(19) United States
(12) Patent Application Publication
(10) Pub. No.: US 2016/0193856 A1
(43) Pub. Date: Jul. 7, 2016

(54) SHEET TRANSPORT ASSEMBLY

(71) Applicant: OCÉ-TECHNOLOGIES B.V., Venlo (NL)

(72) Inventors: Marcel J.H.M. HAENEN, Venlo (NL); Ernest J.J. CLEVERS, Venlo (NL)

(73) Assignee: OCÉ-TECHNOLOGIES B.V., Venlo (NL)

(21) Appl. No.: 14/983,923

(22) Filed: Dec. 30, 2015

(30) Foreign Application Priority Data
Jan. 7, 2015 (EP) 15150235.8

(51) Int. Cl. B41J 11/00; B65H 5/22

(52) U.S. Cl. CPC B41J 11/007; B65H 5/224; B65H 5/228

(57) ABSTRACT

A sheet transport assembly is provided for transporting a sheet along a process unit configured for applying a process to the sheet. The sheet transport assembly comprises a conveying unit comprising a transport belt, which transport belt comprises air permeable openings, the sheet being placed with a contact side on a support surface of the transport belt; a separating unit for separating the sheet from the transport belt, the separating unit comprising a blowing unit connected to an air supply source and arranged adjacent the transport belt to direct a detach air flow through said air permeable openings of the transport belt in a detach area to lift the sheet from the transport belt; and a control unit configured for controlling the units of the sheet transport assembly. The separating unit further comprises a sheet attraction unit arranged for attracting the sheet to the support surface of the transport belt in two attraction areas. Said two attraction areas are cooperatively arranged adjacent to both sides of the detach area in a lateral direction, which is substantially perpendicular to the transport direction. The separating unit further comprises a sheet guidance element arranged facing the support surface of transport belt for separating a leading edge of the sheet from the transport belt, the sheet guidance element comprising a tip arranged proximate to the detach area.

### FIELD OF THE INVENTION

The present invention relates to a sheet transport assembly for transporting a sheet. The present invention further relates to a method for transporting a sheet on a conveying belt unit. The present invention further relates to an inkjet printing apparatus comprising the sheet transport assembly according to the present invention.

### BACKGROUND ART

A known sheet transport assembly is applied in an inkjet printing apparatus, wherein a printing station is arranged as a process unit to apply ink on a receiving substrate, such as a sheet. The sheet transport assembly comprises a conveying unit and the printing station comprises an inkjet print head assembly. The conveying unit comprises a transport belt, such as an endless metallic belt, which comprises air permeable openings, and several deflection rollers arranged for transporting the endless transport belt. A sheet is arranged with a contact side on a support surface of the transport belt and is advanced on the transport belt in a transport path along the printing station wherein an inkjet image is applied onto a process side of the sheet.

The inkjet image is formed by applying dots of an ink, such as an aqueous ink or a non-aqueous ink, on the sheet. In the case of aqueous ink the printed sheet becomes wet on the process side due to the aqueous ink dots. The moisture is absorbed into the sheet and enlarges the fibers of the sheet at the process side of the sheet, depending on the sheet properties. As a result, an internal tension grows in the sheet, and a portion of the sheet may tend to curl downwards towards the transport belt. The curling of the sheet may be prevented by attracting the sheet to the transport belt. This attraction may be supplied by an electrostatic force or a suction pressure provided between the contact side of the sheet and the transport belt.

The sheet transport assembly further comprises a separating unit for separating the sheet from the transport belt, the separating unit comprising a blowing unit connected to an air supply source and arranged adjacent the transport belt to direct a detach air flow through said air permeable openings of the transport belt in a detach area to lift the sheet from the transport belt. The detach air flow provides a detaching force onto the sheet in the detach area for lifting the sheet from the transport belt. During the separation step, the leading edge of the sheet is detached from the transport belt and the sheet is moved in flight to a next transport element, such as another transport belt. The blowing unit may for example be arranged inside a deflection roller, wherein the deflection roller comprises openings for communicating the detach air flow through the air permeable openings of the transport belt to a contact side of the sheet.

However, a sheet being curled towards the transport belt, such as a sheet being curled due to having internal tension, makes it more difficult to separate the leading edge of the sheet from the transport belt. It has been found that the leading edge of the sheet may be directed downwards to the support surface of the transport belt by said curled portion of the sheet. A detach air flow pushing against said downward curled portion of the sheet may leak to lateral sides of the sheet. As a result, the detaching air force for lifting the leading edge from the transport belt is considerably reduced and the leading edge is substantially not lifted from the transport belt.

It is accordingly an object of the present invention to increase the reliability of separating a sheet from the transport belt, which sheet has a portion which has a tendency to curl downwards towards the transport belt due to internal tension.

### SUMMARY OF THE INVENTION

According the present invention, a sheet transport assembly is provided for transporting a sheet along a process unit configured for applying a process to the sheet, the sheet transport assembly comprising:
a conveying unit comprising a transport belt, which transport belt comprises air permeable openings, the sheet being placed with a contact side on a support surface of the transport belt;
a separating unit for separating the sheet from the transport belt, the separating unit comprising a blowing unit connected to an air supply source and arranged adjacent the transport belt to direct a detach air flow through said air permeable openings of the transport belt in a detach area to lift the sheet from the transport belt; and
a control unit configured for controlling the units of the sheet transport assembly; wherein the separating unit further comprises a sheet attraction unit arranged for attracting the sheet to the support surface of the transport belt in two attraction areas, which two attraction areas are cooperatively arranged adjacent to both sides of the detach area in a lateral direction, which is substantially perpendicular to the transport direction, and the separating unit further comprises a sheet guidance element arranged facing the support surface of transport belt for separating a leading edge of the sheet from the transport belt, the sheet guidance element comprising a tip arranged proximate to the detach area.

The detach air flow lifts a portion of the sheet from the transport belt in the detach area. At the same time, side edge portions of the sheet in the lateral direction are attracted to the transport belt in the two attraction areas arranged adjacent to both sides of the detach area in the lateral direction. In this way, the detaching air force of the detach air flow is focused in the detach area, while a leakage of the detach air flow towards lateral sides of the sheet at the attraction areas is substantially hindered. As a result, a first portion of the leading edge of the sheet at the detach area is effectively lifted from the support surface of the transport belt. In a next step, the sheet guidance element, such as the tip of the sheet guidance element, separates the remaining portions of the leading edge of the sheet from the transport belt, which remaining portions are disposed at both sides of the first portion of the leading edge.

The two attraction areas may be arranged separately from one another or may be joined to one another by a third attraction area, which connects said two attraction areas, thereby together forming a common attraction area, which at least in part surrounds the detach area. The third attraction area may be arranged upstream of the detach area and the two attraction areas for attracting the sheet to the support surface of the transport belt upstream in the transport direction.

The attraction force in the attraction areas between the contact side of the sheet and the transport belt may either be an electrostatic force, or a suction pressure provided between the contact side of the sheet and the transport belt, or any other force provided for attracting the contact side of the sheet to the transport belt.

Preferably, the attraction force provided in the attraction areas is controlled, such as controlled by the control unit, to allow slipping of the side edge portions in the lateral direction towards the detach area for allowing the sheet to lift above the detach area in response to the detach air force.

The process unit may be a printing station, such as a printing station comprising a print head assembly configured for providing ink drops on a process side of the sheet, the process side being opposite to the contact side of the sheet. The process unit may also be a drying station for drying the sheet. The process unit may further be any other unit configured for applying a process to the sheet.

In an embodiment, the conveying unit may be arranged to transport the sheet on the transport belt in the transport direction after the sheet has been processed by the process unit upstream of the transport belt in the transport direction. Said sheet may continue to have a tendency for downward curling on the transport belt due to an internal tension in the sheet.

The sheet guidance element may comprise additionally a second tip arranged proximate to the detach area for separating the remaining portions of the leading edge of the sheet from the transport belt. The second tip may be arranged adjacent to the first tip of the sheet guidance element in the lateral direction.

In an embodiment of the sheet transport assembly, the sheet attraction unit is a suction unit arranged adjacent to the transport belt for providing a suction pressure through said air permeable openings of the transport belt in said two attraction areas to attract the sheet to the support surface of the transport belt.

The suction pressure may be easily and accurately controlled by the control unit and said suction pressure is able to controllably attract the sheet to the transport belt in the two attraction areas.

In particular, said suction pressure may be adjusted by the control unit for balancing the attraction force of the suction pressure to the lifting force of the detach air flow. For example, the suction pressure may be controlled to allow sufficient slipping of the side edge portions of the sheet in the lateral direction towards the detach area. In order to allow the lifting of the sheet above the detach area in response to the detach air flow, the suction pressure may be tuned by the control unit in response to a sheet attribute of the sheet, such as a size of the sheet and/or a material type of the sheet.

For example, if the width of the sheet in the lateral direction is smaller and the side portions of the sheet cover only a part of the two attraction areas, the suction pressure may be increased in order to substantially maintain the side portions onto the transport belt. While if the width of the sheet in the lateral direction is larger and the side portions of the sheet fully cover the two attraction areas, the suction pressure may be reduced in order to support sufficient sliding of the side portions of the sheet along the transport belt in the lateral direction for providing space to a middle portion of the sheet, disposed between the side portions, to lift from the transport belt above the detach area.

In an embodiment of the sheet transport assembly, the two attraction areas are arranged extending from the detach area at both sides in the lateral direction. In this embodiment the arrangement of the attraction areas is directly joined to the detach area. This arrangement supports an enhanced control of preventing leakage of the detach air force to the lateral direction by attracting side edge portions to the support surface of the transport belt directly adjacent to the detach area.

In an embodiment of the sheet transport assembly, the detach area and the two attraction areas are arranged at substantially the same position in the transport direction. This arrangement provides an enhanced control of the lifting of the sheet above the detach area, while preventing leakage of the detach air force to the lateral direction by attracting side edge portions of the sheet to the support surface of the transport belt at the same position in the transport direction.

Furthermore this arrangement supports a controlled transport of sheets in the transport direction along the detach area and along the sheet guidance element, for example for a controlled transfer of said sheets to a receiving conveyor downstream of the sheet guidance element.

In an embodiment of the sheet transport assembly, the conveying unit further comprises a second sheet attraction unit arranged for attracting the sheet to the support surface of the transport belt upstream of the two attraction areas in the transport direction. The second sheet attraction unit may be an electrostatic unit for providing electrostatic force, may be a suction unit for providing suction pressure between the contact side of the sheet and the transport belt and may be any other unit for providing an attraction force for attracting the contact side of the sheet to the transport belt.

In particular, the second sheet attraction unit may provide the same attraction force, such as a suction pressure, as the sheet attraction unit for the two attraction areas. The second sheet attraction unit is arranged for maintaining the sheet flat on the support surface of the transport belt upstream of the two attraction areas in the transport direction. This arrangement prevents that side edge portions of the sheet are curled upwards from the transport belt and thereby enhances that the side edge portions are easily attracted and/or maintained on the support surface of the transport belt in the two attraction areas.

In an embodiment of the sheet transport assembly, the tip of the sheet guidance element is arranged facing the detach area. This arrangement further improves the separation of the leading edge of the sheet after the sheet has been lifted above the detach area.

In an embodiment of the sheet transport assembly, the conveying unit comprises a deflection element disposed to deflect the transport belt away from the sheet guidance element proximate to the detach area. The deflection element further enhances the separation of the leading edge of the sheet after the sheet has been lifted above the detach area.

In an embodiment of the sheet transport assembly, wherein the tip is movably arranged in a direction substantially perpendicular to the support surface of the transport belt and is configured to be lifted from the support surface of the transport belt by an air bearing flow provided through the air permeable openings of the transport belt in an air bearing area facing the sheet guidance element. The movable tip may be adjustably arranged at a suitable distance from the support surface of the transport belt for separating the leading edge of the sheet from the transport belt after the sheet has been lifted above the detach area.

In an embodiment of the sheet transport assembly, the detach area includes the air bearing area and wherein the detach air flow includes the air bearing flow for lifting the tip from the support surface of the transport belt in the air bearing area. In this embodiment the detach area is in part arranged facing the sheet guidance element and the air bearing flow is provided by the detach air flow in said part of the detach area. This embodiment provides a simplified control of the movable tip by using the detach air flow for lifting the tip from the support surface of the transport belt in the air bearing area.

In another aspect of the present invention a method is provided for transporting a sheet on a conveying unit along a process unit, the conveying unit comprising a transport belt, which comprises air permeable openings, the method comprising the steps of:
a) placing a sheet with a contact side on a support surface of the transport belt;
b) advancing the sheet in a transport direction along the process unit for applying a process to the sheet;
c) applying a detach air flow through the air permeable openings of the transport belt in a detach area onto the contact side of the sheet to lift the sheet from the transport belt, while attracting the sheet to the support surface of the transport belt in two attraction areas, which two attraction areas are cooperatively arranged adjacent to both sides of the detach area in a lateral direction, which is substantially perpendicular to the transport direction; and
d) separating a leading edge of the sheet from the transport belt by means of a sheet guidance element arranged facing the support surface of the transport belt and comprising a tip arranged proximate to the detach area.

In this method, the detach air flow lifts a portion of the sheet from the transport belt in the detach area. At the same time, side edge portions of the sheet in the lateral direction are attracted to the transport belt in the two attraction areas arranged adjacent to both sides of the detach area in the lateral direction. In this way, the detaching air force of the detach air flow is focused in the detach area, while a leakage of the detach air flow towards lateral sides of the sheet at the attraction areas is substantially hindered. As a result, a first portion of the leading edge of the sheet at the detach area is effectively lifted from the support surface of the transport belt. In a next step, the sheet guidance element, such as the tip of the sheet guidance element, separates the remaining portions of the leading edge of the sheet from the transport belt, which remaining portions are disposed at both sides of the first portion of the leading edge.

In an embodiment of the method, step c) comprises controlling the detach air flow and/or the sheet attraction in response to at least one sheet attribute of the sheet. In particular said detach air flow and/or sheet attraction may be adjusted by the control unit for balancing the attraction force, such as provided by a suction pressure, to the lifting force of the detach air flow. For example, the suction pressure may be controlled to allow sufficient slipping of the side edge portions of the sheet in the lateral direction towards the detach area. In order to allow the lifting of the sheet above the detach area, the suction pressure and the detach air flow may be tuned by the control unit in response to a sheet attribute of the sheet, such as a size of the sheet and/or a material type of the sheet.

In an embodiment of the method, the tip is movably arranged in a direction substantially perpendicular to the support surface of the transport belt, the method further comprising a tip lifting step wherein an air bearing flow is provided through the air permeable openings of the transport belt in an air bearing area onto the sheet guidance element for lifting the tip from the support surface of the transport belt. The movable tip may be adjustably arranged in the tip lifting step at a suitable distance from the support surface of the transport belt for separating the leading edge of the sheet from the transport belt after the sheet has been lifted above the detach area. The tip may be controllably biased towards the transport belt, such as by applying a spring force on the sheet guidance element arranged for pivoting the tip towards the transport belt.

In an embodiment of the method, the tip lifting step is carried out during the advancing step b). This embodiment provides a reduced friction and/or wear of tip on the support surface of the transport belt, thereby improving life time of the transport belt and the tip of the sheet guidance element.

In an embodiment of the method, the tip lifting step is carried out during the sheet lifting step c) and wherein the air bearing flow is provided by the detach air flow of step c). This embodiment provides a simplified control on both the tip lifting and the sheet lifting by using the detach air flow to provide both effects.

In an embodiment of the method, the air bearing flow is controlled independently from the detach air flow. This embodiment provides a more reliable separation as the tip position or distance of the tip from the support surface may be controlled independently from the lifting of the sheet in the detach area.

In another aspect of the present invention, an inkjet printing apparatus is provided comprising the sheet transport assembly according to the present invention, comprising said process unit, wherein the process unit is a printing station comprising a print head assembly configured for providing ink drops on a process side of the sheet, the process side being opposite to the contact side of the sheet.

Further scope of applicability of the present invention will become apparent from the detailed description given hereinafter. However, it should be understood that the detailed description and specific examples, while indicating embodiments of the present invention, are given by way of illustration only, since various changes and modifications within the scope of the present invention will become apparent to those skilled in the art from this detailed description.

### BRIEF DESCRIPTION OF THE DRAWINGS

Hereinafter, the present invention is further elucidated with reference to the appended drawings showing non-limiting embodiments and wherein

FIG. 1 shows a cut sheet image forming system, wherein printing is achieved using a inkjet printing system.

FIGS. 2A-2C show an embodiment of a sheet transport assembly according to the present invention.

FIG. 3 shows in a plane view a modified embodiment of the embodiment shown in FIGS. 2A-2C.

FIGS. 4A-4B show an embodiment of a sheet transport assembly according to the present invention.

FIG. 5 shows in a plane view an embodiment of a sheet transport assembly according to the present invention.

FIG. 6 shows a block diagram of a control system comprising a control unit operating according to embodiments of the method according to the present invention.

### DETAILED DESCRIPTION OF EMBODIMENTS

The present invention will now be described with reference to the accompanying drawings, wherein the same reference numerals have been used to identify the same or similar elements throughout the several views.

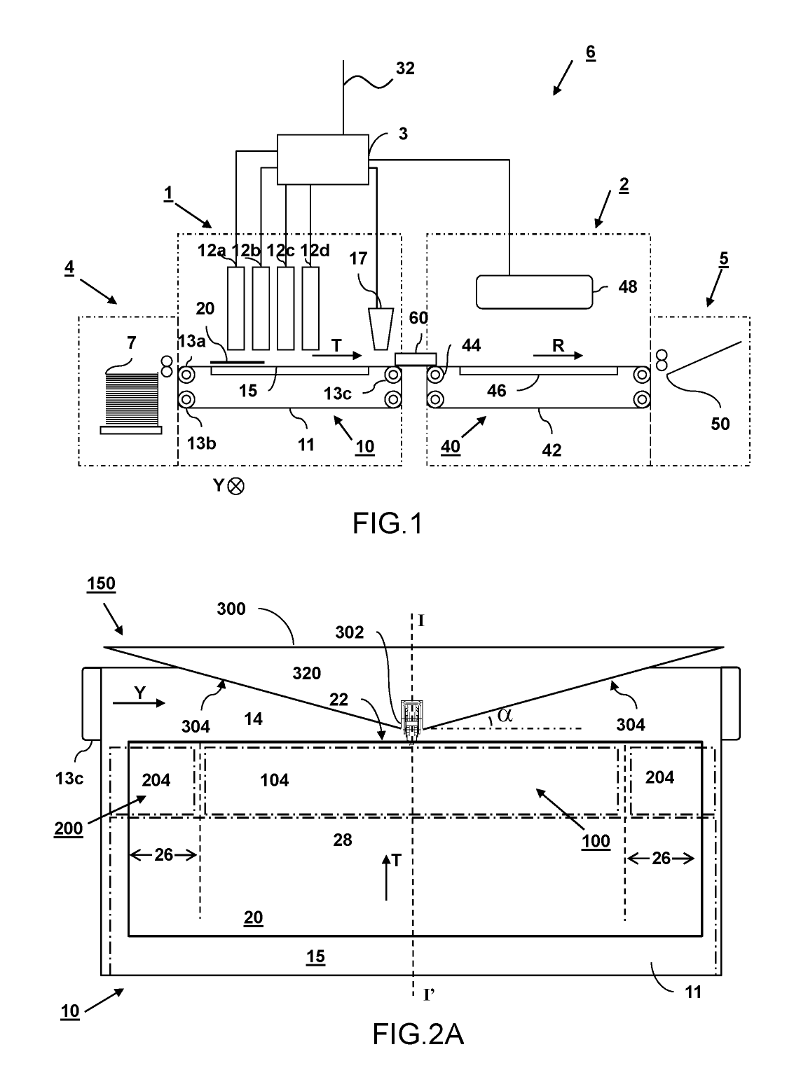

In FIG. 1 an inkjet printing system 6 is shown. The inkjet printing system 6 comprises an inkjet marking module 1, an inkjet print drying module 2 and a data controller 3. The controller is connected to a network through a network cable 32. The print data enters the controller through the network and is further processed. The print data can be saved on a non-volatile memory like a hard disk and sent to the inkjet marking module 1 using an interface board (not shown).

A cut sheet supply module 4 supplies a receiving medium 20 to the inkjet marking module 1. In the cut sheet supply module 4 the receiving medium is separated from a pile 7 and brought in contact with the transport belt 11 of the supplying conveyor 10 of the inkjet marking module 1. The supplying conveyor 10 further comprises an assembly of belt rollers 13a-13c.

The inkjet marking module 1 comprises an assembly of four color inkjet print heads 12a 12d. The transport belt 11 transports the receiving medium 20 to the area beneath the four color inkjet print heads 12a-12d. The colors provided by the inkjet print heads 12a-12d is black, cyan, magenta and yellow. When receiving the print data, the inkjet print heads 12 each generate droplets of inkjet marking material and position these droplets on the receiving medium 20.

The transport belt 11 is transported by the assembly of belt rollers 13a-13c. The transport belt 11 is transported by one roller belt roller 13a in the transport direction of T, and the position of the transport belt 11 in the direction y is steered by means of another belt roller 13b. The transport belt 11 comprises holes and the receiving medium 20 is held in close contact with said belt 11 by means of an air suction device 15.

After the inkjet marking material has been printed on the receiving medium, the receiving medium is moved to an area beneath a scanner module 17. The scanner module 17 determines the position of each of the four color images on the receiving medium 20 and sends this data to the data controller 3.

The receiving medium 20 is transported to by the supplying conveyor 10 towards a receiving conveyor 40 of the inkjet print drying module 2. The receiving conveyor 40 of inkjet print drying module 2 comprises a transport belt 42, which is transported by an assembly of belt rollers 44 in a direction of R. The receiving medium 20 is attracted to the belt by means of a suction unit 46. The receiving medium 20 is dried by the heater device 48. The dried print product is made available on a tray 50 in the print storage module 5. In between the supplying conveyor 10 and the receiving conveyor 40 a sheet separation unit 60 is arranged for separating a sheet from the supplying conveyor 10 to transfer to the sheet to the receiving conveyor 40. Said separation unit 60 may for example be the sheet separation unit according to the present invention.

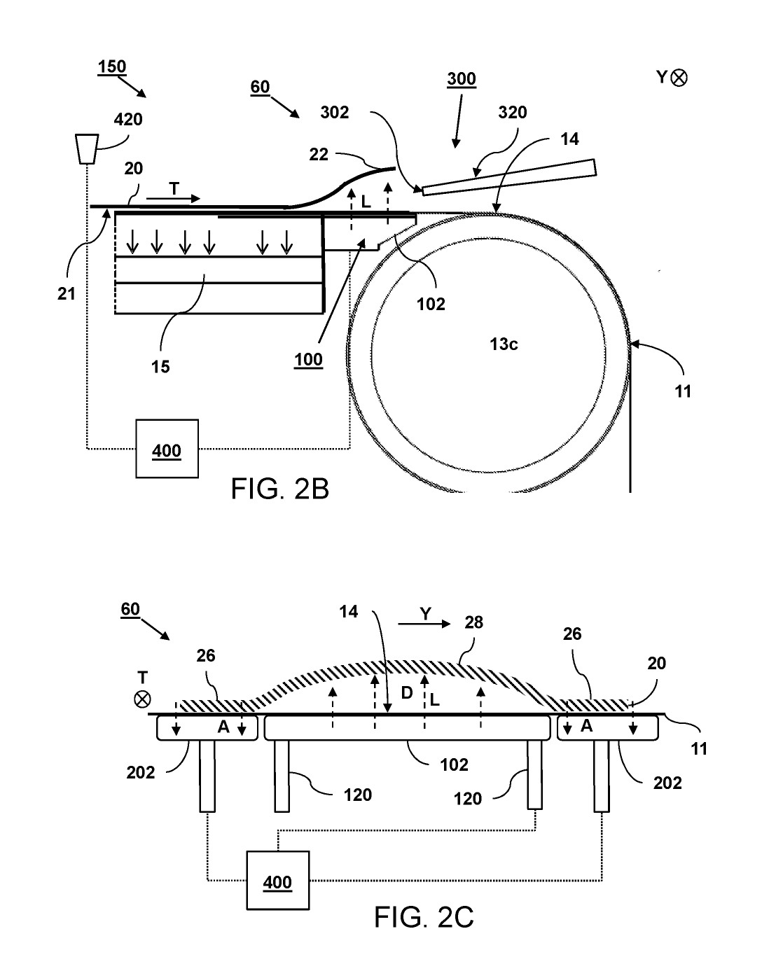

Now referring to FIGS. 2A-2C showing an embodiment of a sheet transport assembly according to the present invention.

FIG. 2A shows an enlarged plane view of the sheet transport assembly 150 comprising the conveying unit 10 shown in FIG. 1. In FIG. 2A the transport belt 11 and one of the deflection rollers 13c is shown of the conveying unit 10. The sheet transport assembly 150 further comprises a separating unit 60 comprising a blowing air knife 100, a suction unit 200, a sheet guidance element 300 and a control unit 400 (shown in FIG. 2B).

Both the blowing air knife 100 and the suction unit 200 are connected to an air supply source (not shown). The blowing air knife 100 comprises an outlet 102 extending over a detach area 104 for directing a detach air flow L onto a contact side of the 21 of the sheet 20. The detach area 104 is arranged covering a middle portion of the sheet 28 for lifting the middle portion of the sheet 28 from the support surface of the transport belt 14.

The suction unit 200 comprises two outlets 202 extending over two attraction areas 204, which two attraction areas 204 are cooperatively arranged adjacent to both sides of the detach area 104 in a lateral direction Y, which is substantially perpendicular to the transport direction T. The two attraction areas 204 are arranged for attracting two side edge portions 26 of the sheet to the support surface 14 of the transport belt 11 by providing a suction pressure through air permeable holes of the transport belt 11 to the contact side of the sheet 21. The two attraction areas 204 are arranged at substantially the same position in the transport direction T as the detach area 104. The two attraction areas 204 are arranged sub sequent to the suction unit 15 in the transport direction in order that the side edge portions 26 are maintained flat on the support surface of the transport belt 14 during transport along the suction unit 15 and the two attraction areas 204.

As shown in FIG. 2A the sheet guidance element 300 comprises a tip 302 arranged closed to the detach area 104, a support surface 320 for supporting the contact side 21 of the sheet and two guidance edges 304 arranged at both sides of the tip 302 in the lateral direction Y. The tip 302 is arranged substantially in a central position of the detach area 104 in between the two attraction areas 204 in the lateral direction Y. The tip 302 is arranged at a distance from the support surface of the transport belt 14 to separate the leading edge of the sheet 22 from the transport belt 14.

Now referring to FIG. 2B showing a cross section view of the sheet transport assembly 150 along the line I-I′ shown in FIG. 2A. A sheet 20 is placed with a contact side 21 (as shown in FIG. 2B) on a support surface of the transport belt 14 and advanced by the transport belt 11 in a transport direction T by moving the transport belt in the transport direction T towards the deflection roller 13c. The sheet is attracted to the support surface of the transport belt 14 by a suction unit 15 which is arranged adjacent to the transport belt 11 for providing a suction pressure through the air permeable openings of the transport belt 11 to the contact side of the sheet 21. The control unit 400 is connected to a sensor 320 arranged for detecting a leading edge 22 of the sheet.

In FIGS. 2A and 2B the leading edge 22 of the sheet 20 has advanced up to the sheet guidance element 300. As shown in FIG. 2B and in FIG. 2C the leading edge 22 at the middle portion 28 has been lifted from the support surface 14 of the transport belt 11 in response to the detach air flow L while at the same time the side edge portions 26 are maintained close to the support surface 14 of the transport belt 11 (as is shown in FIG. 2C).

The tip 302 separates the leading edge 22 of the sheet from the transport belt 11. Each guidance edge 304 is arranged at an acute angle α with respect to the lateral direction Y, wherein said angle α is about 10-30 degrees. The guidance edges 304 are arranged for guiding the leading edge 22 and side edges of the sheet 20 onto the support surface 320 of the sheet guidance element 300.

The guidance edges 304 further separate remaining portions of the leading edge 22 from the transport belt 11 when the sheet 20 further advances in the transport direction T, such as guiding the side edge portions of the sheet 26 from the transport belt 11 to the support surface 320. Especially in case corners of the sheet 20 at the side edge portions 26 are curled downwards towards the transport belt 11, the guidance edges 304 guide the corners of the sheet 20 onto the support surface 320 of the sheet guidance element 300.

The guidance surface 320 is arranged substantially parallel to the transport direction T. Alternatively the guidance surface 320 may be arranged at a small angle with respect to the transport direction T for further lifting the sheet 20 from the transport belt 11 upwards in the direction of the process side of the sheet 20.

Now referring to FIG. 2C wherein a cross section view is shown of the blowing air knife 100 and the suction unit 200 in the lateral direction Y. The suction unit 202 comprises two outlets 202 arranged adjacent to the transport belt 11 at both sides of the outlet 102 of the blowing air knife 100 in the lateral direction Y. The two outlets 202 are arranged at a certain distance from the outlet 102 in the lateral direction Y such that the detach air flow L provided by the outlet 102 is substantially separated from the suction pressures A provided by the outlets 202. As a result a sufficient detach air force is generated in the space D between the outlet 102 of the blowing air knife 100 and the middle portion of the sheet 28. The middle portion of the sheet 28 is at least in part lifted from the support surface 14 of the transport belt while the side edge portions of the sheet 26 are maintained close to the support surface 14 of the transport belt.

The detach air flow L is provided to the outlet 102 by supply of air through two air supply tubes 120 arranged at both ends of the outlet 102 in the lateral direction Y. As a result the detach air flow L in this embodiment has a maximum amplitude of air flow velocity in between both air supply tubes 120. This peak configuration of the detach air flow L is arranged to further enhance the lifting of the middle portion of the sheet 28 proximate to the tip 302 of the sheet guidance element 300.

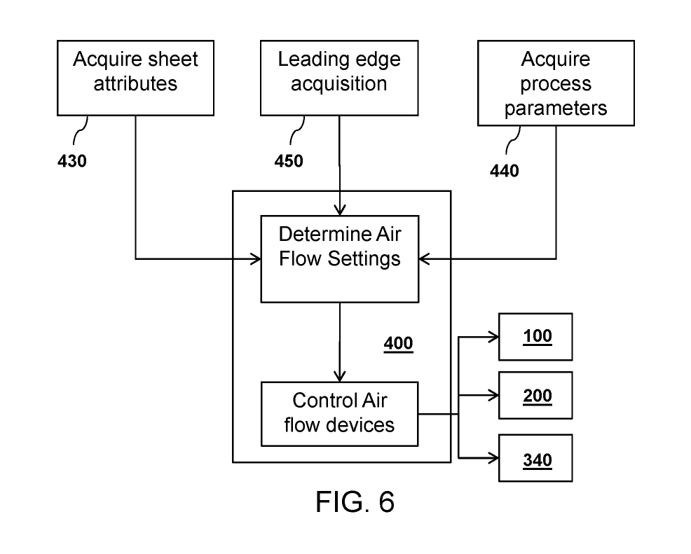

The detach air flow L in the detach area 104 and the suction pressures A in the attraction areas 204 are controlled by the control unit 400. Operation of control unit 400 is further explained in relation to FIG. 6.

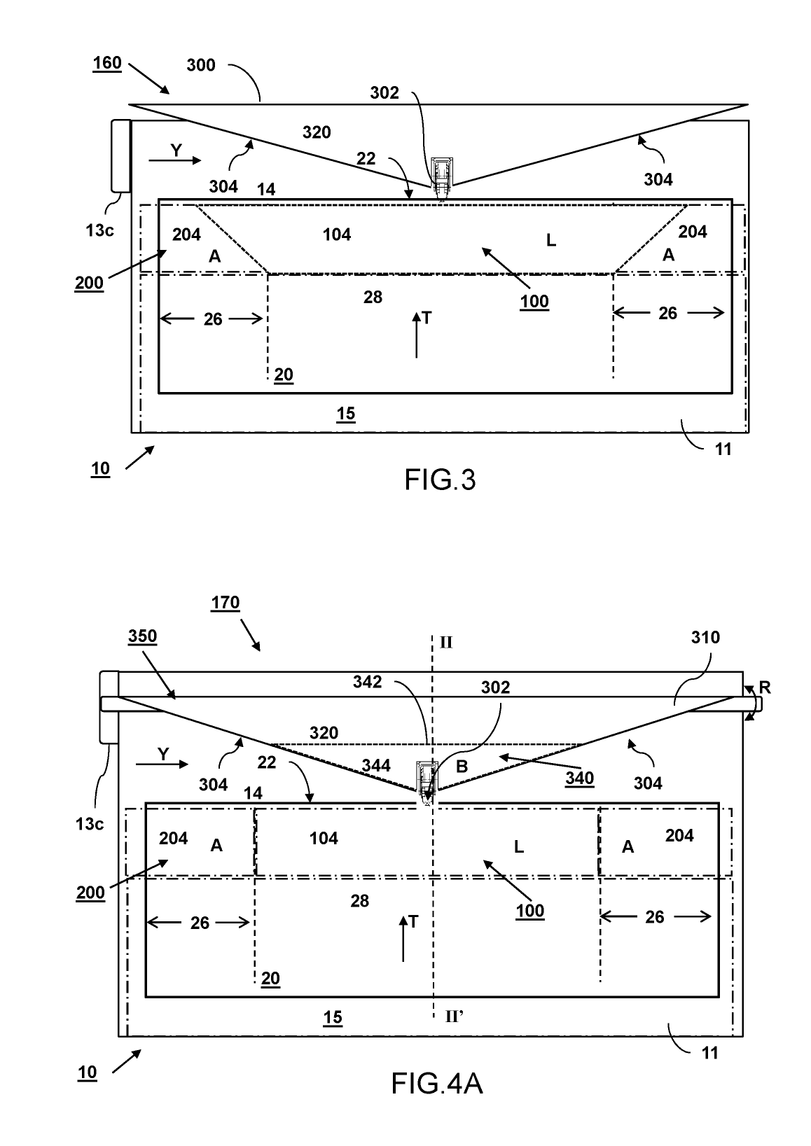

Now referring to FIG. 3 showing in a plane view a modified embodiment of the embodiment shown in FIGS. 2A-2C. The sheet transport assembly 160 comprises the conveying unit 10, which is shown in FIG. 1, and a separating unit comprising a blowing air knife 100, a suction unit 200, a sheet guidance element 300 and a control unit 400 (not shown).

The blowing air knife 100 comprises an out outlet in a detach area 104, wherein the detach area 104 has a tapered shape, which broadens in the lateral direction Y relative to a sheet moving in the transport direction T. The suction unit 200 comprises two attraction areas 204 cooperatively arranged adjacent to both sides of the detach area 104 in the lateral direction Y. The two attraction areas 204 are arranged substantially joining to the detach area 104, each having a width in the lateral direction, which width decreases relative to a sheet moving in the transport direction T.

As a result of the tapered shapes of the detach area 104 and the two attraction areas 204, the middle portion 28 of the sheet, which is lifted by the detach air flow L, broadens when the sheet moves along the detach area 104 in the transport direction T. At the same time the side edge portions 26 of the sheet, which are maintained close to the transport belt 11 by the suction pressure A, reduces in width along the transport direction T.

This arrangement provides flexibility to various sizes of sheets 20 having a different width in the lateral direction Y. In particular the attraction force provided by the suction pressure A reduces in the transport direction while the detach air force provided by the detach air flow L increases. As such the arrangement allows a controlled slipping of the side edge portions of the sheet 26 in the lateral direction Y towards the detach area 104 for various sheets. As a result lifting of the middle portion of the sheet 28 above the detach area 104 is enhanced for various sheets.

The sheet guidance element 300 comprises a tip 302 arranged close to the detach area 104, a support surface 320 for supporting the contact side 21 of the sheet and two guidance edges 304 arranged at both sides of the tip 302 in the lateral direction Y. The tip 302 is arranged at a distance from the support surface of the transport belt 14 to separate the leading edge of the sheet 22 from the transport belt 14.

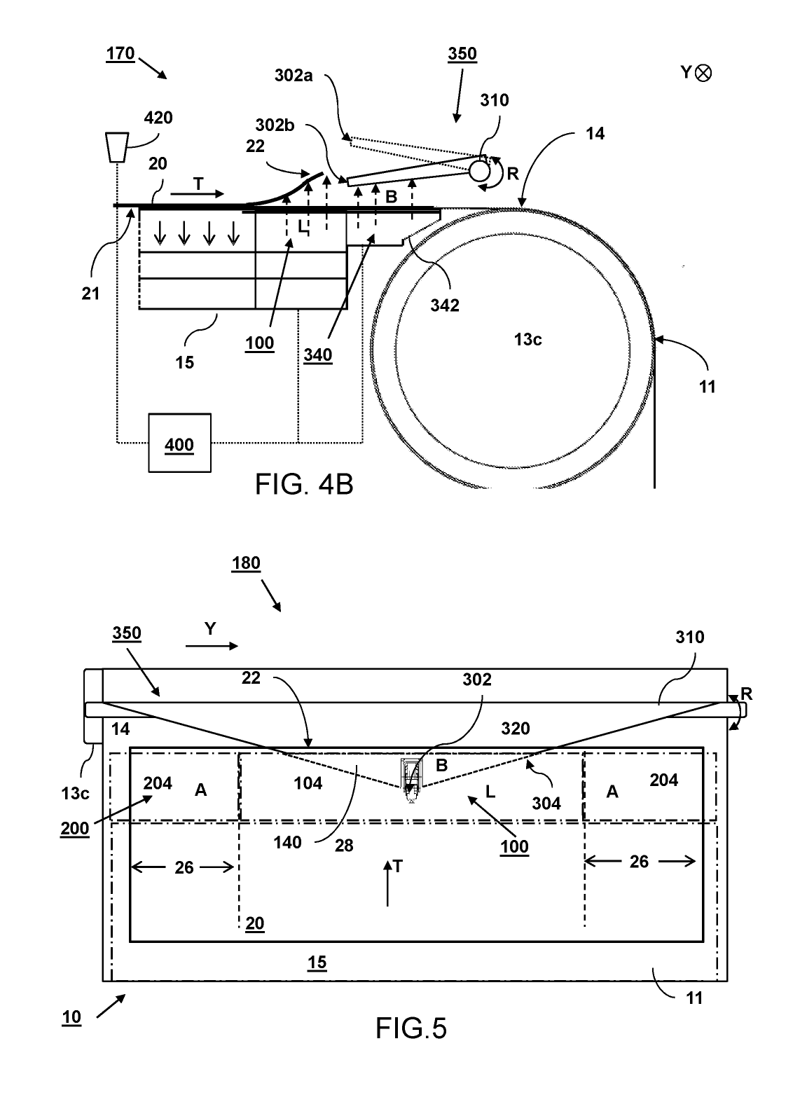

Now referring to FIGS. 4A-4B showing an embodiment of a sheet transport assembly according to the present invention.

FIG. 4A shows an enlarged plane view of the sheet transport assembly 170 comprising the conveying unit 10 shown in FIG. 1. In FIG. 4A the transport belt 11 and one of the deflection rollers 13c is shown of the conveying unit 10. The sheet transport assembly 170 further comprises a separating unit 60 comprising a blowing air knife 100, a suction unit 200, a sheet guidance element 350, an air bearing unit 340 and a control unit 400 (shown in FIG. 4B).

FIG. 4B shows a cross section view of the sheet transport assembly 170 along the line II-II′ shown in FIG. 4A. A sheet 20 is placed with a contact side 21 (as shown in FIG. 4B) on a support surface of the transport belt 14 and advanced by the transport belt 11 in a transport direction T by moving the transport belt in the transport direction T towards the deflection roller 13c. The sheet is attracted to the support surface of the transport belt 14 by a suction unit 15 which is arranged adjacent to the transport belt 11 for providing a suction pressure through the air permeable openings of the transport belt 11 to the contact side of the sheet 21. The control unit 400 is connected to a sensor 320 arranged for detecting a leading edge 22 of the sheet.

The blowing air knife 100 and the suction unit 200 are similar to the embodiment shown in FIGS. 2A-2C. The sheet guidance element 350 comprises a tip 302 arranged close to the detach area 104, a support surface 320 for supporting the contact side 21 of the sheet, two guidance edges 304 arranged at both sides of the tip 302 in the lateral direction Y. The sheet guidance element 350 further comprises an axle 310, which is connected to the support surface 320 and which is rotatable arranged in a direction indicated by arrow R for positioning the tip 302 at a distance from the transport belt 11 by a pivoting movement of the tip 302.

The air bearing unit 340 is coupled to an air supply source (not shown) and comprises an outlet 342 arranged adjacent to the transport belt 11 facing a part of the sheet guidance element 350. The outlet 342 is arranged to direct an air bearing flow B through the air permeable openings of the transport belt 11 in an air bearing area 344 to the sheet guidance element 350. In the plane view shown in FIG. 4A the air bearing area 344 is arranged beneath the sheet guidance element 350 as indicated by the dashed line.

The air bearing flow B is provided onto the sheet guidance element 350 to lift the tip 302 in a direction substantially perpendicular to the support surface of the transport belt 14, thereby arranging the tip 302 at a distance from the support surface of the transport belt 14 suitable for separating the leading edge of the sheet 22 from the transport belt 11 after the leading edge of the sheet 22 has been lifted from the transport belt 11 above the detach area 104.

For example as is shown in FIG. 4B the air bearing flow B may be reduced in order to lower the tip from a first position 302a to a second position 302b, thereby reducing the distance between the tip 302 and the support surface of the transport belt 14.

During the advancing of the sheet 20 on the transport belt 11 of the supplying conveyor 10 the tip 302 may be positioned in the first position 302a, such that the tip 302a does not damage nor wear the support surface of the transport belt 14. While during the separation of the leading edge of the sheet 22, the tip may be temporarily lowered to the second position 302b close to support surface of the transport belt 14 in order to facilitate the separation of the leading edge of the sheet 22.

The tip 302 may be biased towards the support surface of the transport belt 14 by a spring (not shown) acting on the axle 310 to pivot the sheet guidance element 350 including the tip 302 around the axle 310 as indicated by arrow R towards the transport belt 11 when no air bearing flow B is provided.

Additionally the axle 310 may be connected to a cam assembly (not shown) arranged for restricting the rotational movement of the axle 310 to restrict an upward pivoting movement of the tip 302. As a result the tip may be held stationary in the first position 302a, which provides a maximum distance between the tip 302 and the support surface of the transport belt 14. This arrangement enhances an easy control of the position of the tip 302 and distance of the tip 302 above the support surface of the transport belt 14.

Now referring to FIG. 5 showing an embodiment of a sheet transport assembly according to the present invention. FIG. 5 shows an enlarged plane view of the sheet transport assembly 180 comprising the conveying unit 10 shown in FIG. 1. The sheet transport assembly 180 further comprises a separating unit comprising a blowing air knife 100, a suction unit 200, a sheet guidance element 350 and a control unit (not shown).

A sheet 20 is placed with a contact side on a support surface of the transport belt 14 and advanced by the transport belt 11 in a transport direction T by moving the transport belt in the transport direction T towards a deflection roller 13c. The sheet is attracted to the support surface of the transport belt 14 by a suction unit 15 which is arranged adjacent to the transport belt 11 for providing a suction pressure through the air permeable openings of the transport belt 11 to the contact side of the sheet.

The blowing air knife 100 and the suction unit 200 are similar to the embodiment shown in FIGS. 4A-4B. The sheet guidance element 350 comprises a tip 302 arranged facing the detach area 104, a support surface 320 for supporting the contact side 21 of the sheet, two guidance edges 304 arranged at both sides of the tip 302 in the lateral direction Y. The sheet guidance element 350 further comprises an axle 310, which is rotatable arranged in a direction indicated by arrow R for positioning the tip 302 at a distance from the transport belt 11 by a pivoting movement of the tip 302.

The sheet guidance element 350 is arranged in part facing the detach area 104. In the detach area 104 a detach air flow L is provided for lifting the middle portion of the sheet 28. The detach area 104 includes an air bearing area 140, wherein the detach air flow L provides an air bearing flow B between the sheet guidance element 350 and the support surface of the transport belt 14 for lifting the tip 302 from the support surface of the transport belt 14. This arrangement simplifies the control of the position of the tip 302 as no separate air bearing unit is needed for providing the air bearing flow B.

The axle 310 in this embodiment is connected to a cam assembly (not shown) arranged for restricting the rotational movement of the axle 310 to restrict an upward pivoting movement of the tip 302. As a result the tip may be held stationary in a position, which provides a maximum distance between the tip 302 and the support surface of the transport belt 14. This arrangement enhances an easy control of the position of the tip 302 and distance of the tip 302 above the support surface of the transport belt 14, wherein the detach air flow L may be further increased for lifting the middle portion of the sheet 28 independently of lifting the tip 302.

In FIG. 5 the leading edge 22 at the middle portion 28 has been lifted from the transport belt 11 by the detach air flow L and is separated by the tip 302 from the transport belt 11. The guidance edges 304 are in part arranged over the detach area 104. The guidance edges 304 separate remaining portions of the leading edge 22 from the transport belt 11, while the sheet 20 is advanced in the transport direction T. A contact side of the sheet 20 is supported on the support surface 320 of the sheet guidance element 350.

The detach air flow L in the detach area 104 and the suction pressures A in the attraction areas 204 are controlled by the control unit 400, which is shown in FIG. 6. Operation of control unit 400 is further explained in relation to FIG. 6.

Now referring to FIG. 6 showing a block diagram of a control system comprising a control unit operating according to embodiments of the method according to the present invention.

In the embodiments shown in FIGS. 2A-5 the blowing air knife 100, suction unit 200 and/or air bearing unit 340 are controlled by the control unit 400. The control unit 400 controls the air flows provided by the air blowing knife 100 and air bearing unit 340 in respect of air flow settings shown in FIG. 6 as air flow pressure [bar], air flow volume [I/min], air flow speed [m/s] and air flow timing [ms]. The air flow pressure is controlled in the range of 0-5 bar. The air flow volume is controlled in the range of 0-200 l/min per air flow knife. The air flow volume depends on the air flow restrictions of the respective air knifes and on the air flow pressure. The air flow speed is controlled in the range of 0-50 m/s and also depends on the air flow restrictions of the respective air knifes and on the air flow pressure.

The control unit 400 controls the suction pressure A provided by the suction unit 200 in respect of suction pressure [bar], suction air flow volume [l/min] and suction timing [ms]. The timing of the respective blowing air knife 100, suction unit 200 and/or air bearing unit 400 is important for the functioning of the separating unit.

The control unit 400 determines the timing [ms] based on sheet attributes 430 of the sheet 20, such as material types, media thickness and sheet sizes, and/or based on process parameters 440 of the sheet 20, such as advancing speed of the transport belt 11 in the transport direction T and such as ink coverage of the sheet 20 based on print data and droplet sizes used. Furthermore the control unit 400 determines a starting timing [ms] of the air flow and suction timing in response to receiving a leading edge acquisition 450 from the sensor 420.

In particular said detach air flow L provided by the blowing air knife 100 and/or sheet attraction A may be adjusted by the control unit for balancing the attraction force, such as provided by the suction unit 200, to the lifting force of the detach air flow L. For example the suction pressure A may be controlled to allow sufficient slipping of the side edge portions of the sheet 26 in the lateral direction Y towards the detach area 104. In order to allow the lifting of the sheet above the detach area 104, the suction pressure A and the detach air flow L may be tuned by the control unit 400 in response to a sheet attribute of the sheet 430, such as a size of the sheet and/or a material type of the sheet.

Examples of sheet attributes 430 are coated media, plain paper, coated, paper, offset paper, grammage of the media (e.g. in g/m2), or any other relevant sheet attributes 430 which are related to curl behavior of the sheet 20 due to internal tension in the sheet in response to a process unit. For example a stiffness of the sheet 20 is related to curl behavior of the sheet 20. The control unit 400 comprises or is connected to a database comprising sheet attributes 330 which are related to optimal air flow settings.

Detailed embodiments of the present invention are disclosed herein; however, it is to be understood that the disclosed embodiments are merely exemplary of the present invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. In particular, features presented and described in separate dependent claims may be applied in combination and any advantageous combination of such claims is herewith disclosed.

Further, the terms and phrases used herein are not intended to be limiting; but rather, to provide an understandable description of the present invention. The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly.

The present invention being thus described, it will be obvious that the same may be varied in many ways. Such variations are not to be regarded as a departure from the spirit and scope of the present invention, and all such modifications as would be obvious to one skilled in the art are intended to be included within the scope of the following claims.

1. A sheet transport assembly for transporting a sheet along a process unit configured for applying a process to the sheet, the sheet transport assembly comprising:
a conveying unit comprising a transport belt, which transport belt comprises air permeable openings, the sheet being placed with a contact side on a support surface of the transport belt;
a separating unit for separating the sheet from the transport belt, the separating unit comprising a blowing unit connected to an air supply source and arranged adjacent the transport belt to direct a detach air flow through said air permeable openings of the transport belt in a detach area to lift the sheet from the transport belt; and
a control unit configured for controlling the units of the sheet transport assembly;
wherein the separating unit further comprises a sheet attraction unit arranged for attracting the sheet to the support surface of the transport belt in two attraction areas, which two attraction areas are cooperatively arranged adjacent to both sides of the detach area in a lateral direction, which is substantially perpendicular to the transport direction; and
the separating unit further comprises a sheet guidance element arranged facing the support surface of transport belt for separating a leading edge of the sheet from the transport belt, the sheet guidance element comprising a tip arranged proximate to the detach area.

2. The sheet transport assembly according to claim 1, wherein the sheet attraction unit is a suction unit arranged adjacent to the transport belt for providing a suction pressure through said air permeable openings of the transport belt in said two attraction areas to attract the sheet to the support surface of the transport belt.

3. The sheet transport assembly according to claim 1, wherein the detach area and the two attraction areas are arranged at substantially the same position in the transport direction.

4. The sheet transport assembly according to claim 1, wherein the conveying unit further comprises a second sheet attraction unit arranged for attracting the sheet to the support surface of the transport belt upstream of the two attraction areas in the transport direction.

5. The sheet transport assembly according to claim 1, wherein the tip of the sheet guidance element is arranged facing the detach area.

6. The sheet transport assembly according to claim 1, wherein the conveying unit comprises a deflection element disposed to deflect the transport belt away from the sheet guidance element proximate to the detach area.

7. The sheet transport assembly according to claim 1, wherein the tip is movably arranged in a direction substantially perpendicular to the support surface of the transport belt and is configured to be lifted from the support surface of the transport belt by an air bearing flow provided through the air permeable openings of the transport belt in an air bearing area facing the sheet guidance element.

8. The sheet transport assembly according to claim 7, wherein the detach area includes the air bearing area and wherein the blowing unit is configured for providing the air bearing flow for lifting the tip from the support surface of the transport belt in the air bearing area.

9. A method for transporting a sheet on a conveying unit along a process unit, the conveying unit comprising a transport belt, which comprises air permeable openings, the method comprising the steps of:
a) placing a sheet with a contact side on a support surface of the transport belt;
b) advancing the sheet in a transport direction along the process unit for applying a process to the sheet;
c) applying a detach air flow through the air permeable openings of the transport belt in a detach area onto the contact side of the sheet to lift the sheet from the transport belt, while attracting the sheet to the support surface of the transport belt in two attraction areas, which two attraction areas are cooperatively arranged adjacent to both sides of the detach area in a lateral direction, which is substantially perpendicular to the transport direction; and
d) separating a leading edge of the sheet from the transport belt by means of a sheet guidance element arranged facing the support surface of the transport belt and comprising a tip arranged proximate to the detach area.

10. The method for transporting the sheet according to claim 9, wherein step c) comprises controlling the detach air flow and/or the sheet attraction in response to at least one sheet attribute of the sheet.

11. The method for transporting the sheet according to claim 9, wherein the tip is movably arranged in a direction substantially perpendicular to the support surface of the transport belt, the method further comprising a tip lifting step wherein an air bearing flow is provided through the air permeable openings of the transport belt in an air bearing area onto the sheet guidance element for lifting the tip from the support surface of the transport belt.

12. The method for transporting the sheet according to claim 11, wherein the tip lifting step is carried out during the advancing step b).

13. The method for transporting the sheet according to claim 11, wherein the tip lifting step is carried out during the sheet lifting step c) and wherein the air bearing flow is provided by the detach air flow of step c).

14. The method for transporting the sheet according to claim 11, wherein the air bearing flow is controlled independently from the detach air flow.

15. An inkjet printing apparatus comprising the sheet transport assembly according to claim 1, comprising said process unit, wherein the process unit is a printing station comprising a print head assembly configured for providing ink drops on a process side of the sheet, the process side being opposite to the contact side of the sheet.
